(19) United States
(12) Patent Application Publication
(10) Pub. No.: US 2004/0017522 A1
(43) Pub. Date: Jan. 29, 2004

(54) Display-oriented computer casing

(76) Inventor: Chiang-Hai Tsai, Tucheng City (TW)

Correspondence Address: Chiang-Hai Tsai, P.O. Box No.6-57, Chung-Ho, Taipei, 235, TW

(21) Appl. No.: 10/345,277

(22) Filed: Jan. 16, 2003

(30) Foreign Application Priority Data
Jul. 25, 2002 (TW) 091211373

(51) Int. Cl. G02F 1/1333

(52) U.S. Cl. 349/58

(57) ABSTRACT

The display-oriented computer casing of the invention includes a front panel, a rear panel, a left panel, a right panel, a top panel, a bottom panel, two partition panels and a plurality of combining members and screws; wherein the aforesaid panels and combining members are made of acrylic materials for revealing a panel design that is multi-color and transparent at one's choice, and for further showing a delicate visual effect through illumination, thereby mostly directly presenting the interior of the computer casing as well as achieving artistic and coordinative purposes.

### BACKGROUND OF THE INVENTION

(a) Field of the Invention

The invention relates to a display-oriented computer casing comprising acrylic assemblies that are colorful and transparent, thereby displaying the new components and boards therein.

(b) Description of the Related Art

Accompanied with the flourishing of the information industry and technology, renovations of various computer assemblies change with each passing day. Streams of people and subsequent purchase demands arise in annual information tradeshows held regularly, in which major vendors, without exception, exert best promotional strategies possible in order to distinguish the characteristics of their new products.

In those occasions, as a result of diverse designs and DIY trend developed by amateurs, the computer casings regarded as the appearance of CPU's are thus able to offer consumers with a wide range of choices. However, materials of computer casings used in trade shows differ from those of conventional casings. In conventional casings, components are disposed in casings that forbid viewing the interiors thereof, and therefore vendors generally adopt the prior method described below in order to present characteristics of the product being displayed.

Components are disposed within a conventional computer casing, wherein a side panel is placed and unsecured on the casing, thus exhibiting the new components within the interior thereof through the open casing. However, such method of display occurs somewhat unsophisticated and unattractive, and additional spotlights are necessitated upon the opaque and dark areas within the interior thereof; or even more directly, the components are laid out in a horizontal manner for achieving another kind of visual effect. Compared with the above method that has been implemented long since, the present invention provides a more complete and display-oriented computer casing which is more labor-saving in assembly and disassembly. The computer casing in accordance with the invention comprises a variety of transparent acrylic panels combined by screws using multiple collocations for revealing a transparent texture as a whole, and for further directly exhibiting the interior and configuration within the casing, thereby achieving the requirements and effects of display.

### SUMMARY OF THE INVENTION

Therefore the object of the invention is to provide a display-oriented computer casing that is able to offer consumers with an innovation and another choice for assembly.

For accomplishing the aforesaid object, the display-oriented computer casing in accordance with the invention includes a front panel, a rear panel, a left panel, a right panel, a bottom panel, two partition panels, and a plurality of combining members and screws. Acrylic materials are adopted for making the above panels and combining members for revealing a panel design of multi-colors and a transparent texture. Assembly thereof may then be carried out at one's choice for exhibiting the boards and components disposed within the interior thereof, and thus showing a delicate visual effect using appropriate illumination. The display is then presented in a most directly method for enhancing artistic and coordinative purposes.

### BRIEF DESCRIPTION OF THE DRAWINGS

FIG. 1 shows a first exploded assembly schematic view of respective panels according to the invention.

FIG. 2 shows a second exploded assembly schematic view of respective panels according to the invention.

FIG. 3 shows a third exploded assembly schematic view of respective panels according to the invention.

FIG. 4 shows a fourth exploded assembly schematic view of respective panels according to the invention.

FIG. 5 shows a fifth exploded assembly schematic view of respective panels according to the invention.

FIG. 6 shows an elevational assembly schematic view according to the invention.

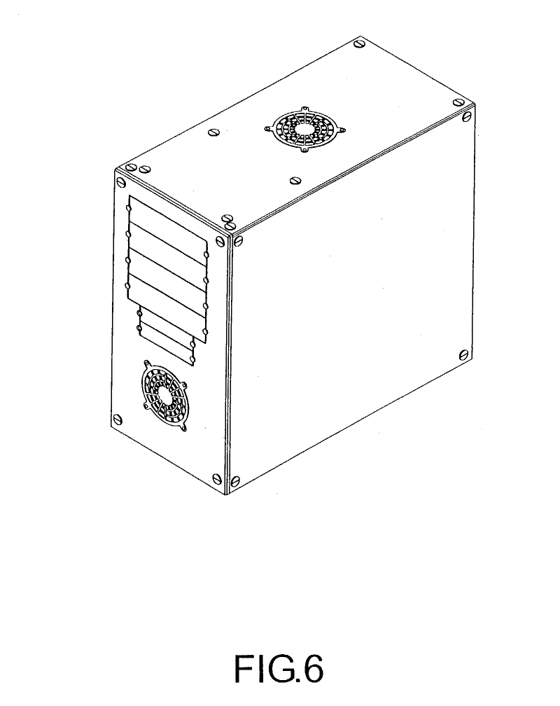

### DESCRIPTION OF THE PREFERRED EMBODIMENTS

To better understand the structure and function of the invention, a preferred embodiment shall be given hereunder with the accompanying drawings.

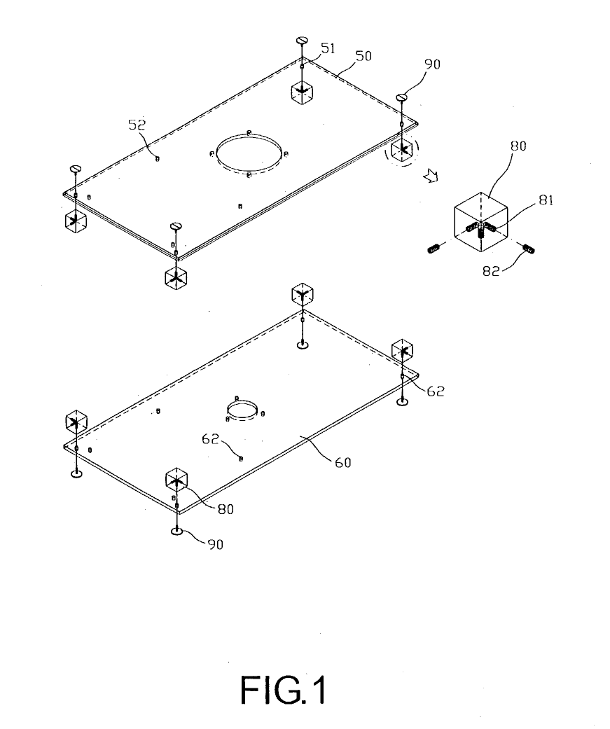

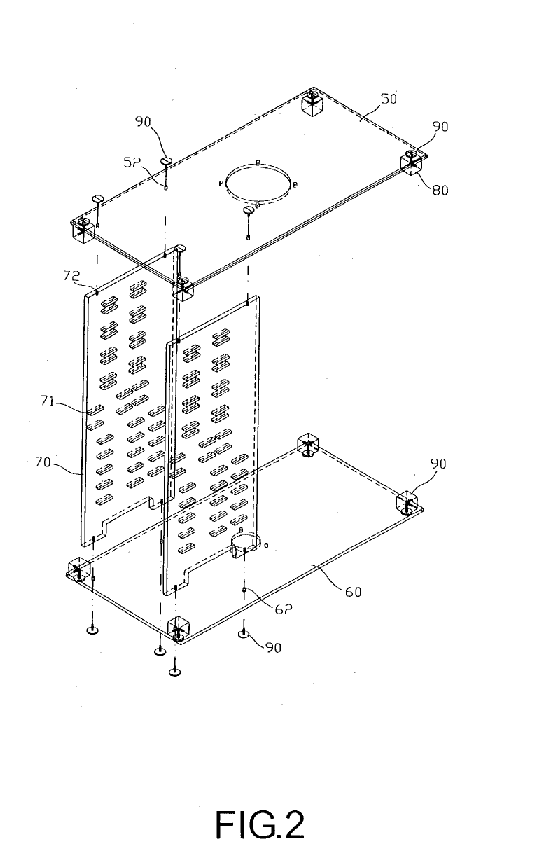

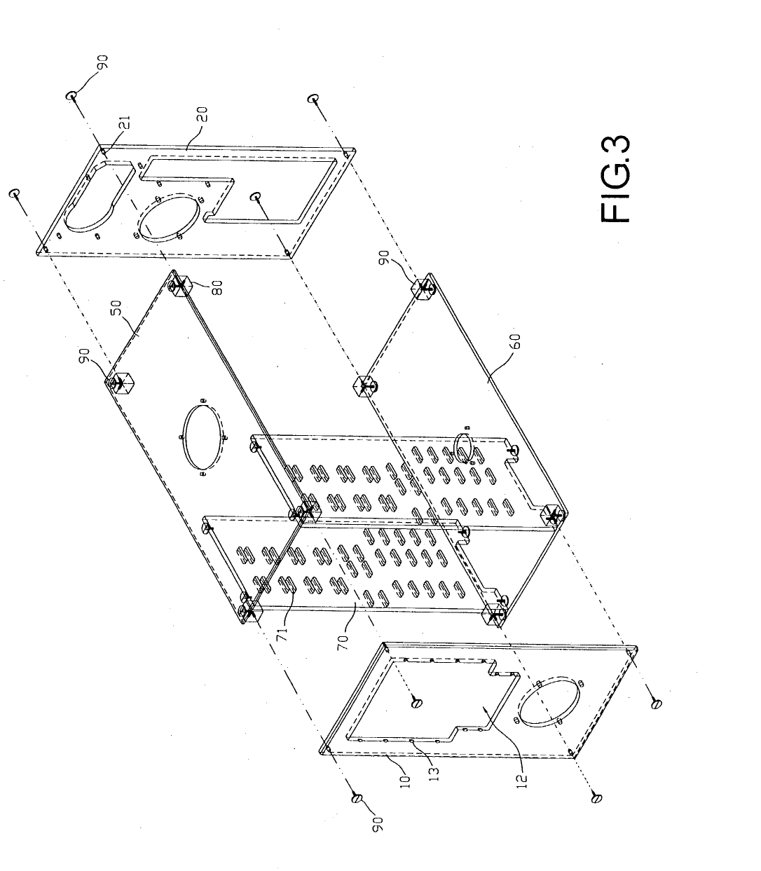

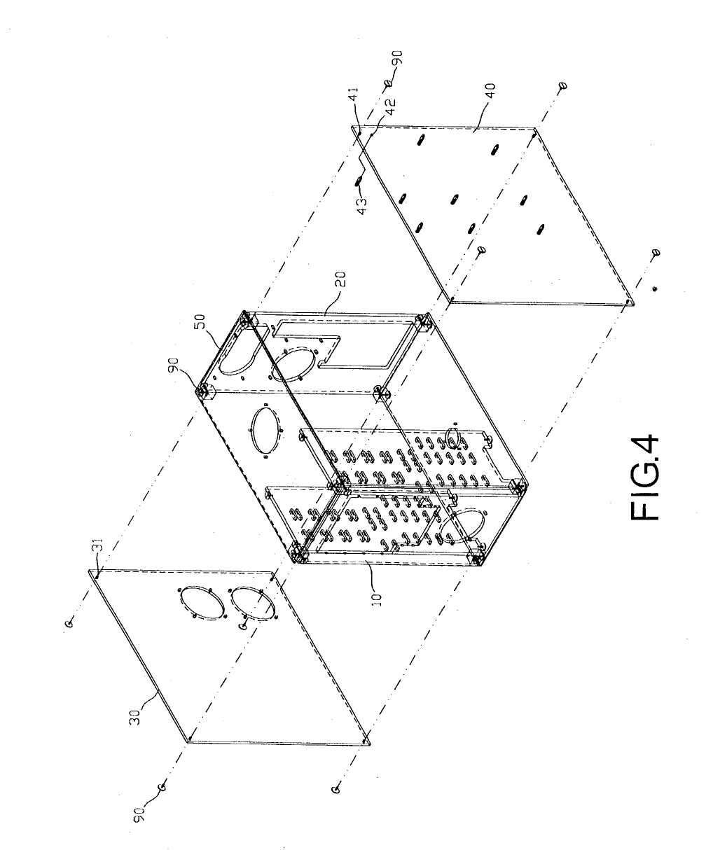

Referring to FIGS. 1 to 5 showing the exploded assembly schematic views of respective panels, the computer casing in accordance with the invention comprises a front panel 10, a rear panel 20, a left panel 30, a right panel 40, a top panel 50, a bottom panel 60, two partition panels 70, and a plurality of combining members 80 and screws 90.

Wherein, the aforesaid panels and the combining members are made of acrylic materials such that the panels for assembly appear as multi-color and transparent. Not only the spaces and disposed components within the interior of the computer casing are presented in a best and most direct way, but also new product promotions aimed at trade shows are achieved. (Comparing with a conventional computer casing, which is generally made of metal or plastic materials, opaque areas are resulted within the conventional computer casing. Also, because of different occasions of usage, the appearances of such conventional casings remains unchanged although through development. However, the labor-saving assembly and screw-free characteristics of the conventional casing shall be excluded from the comparison.)

The panels described above for forming the computer casing are divided into six outer panels and two inner partition panels 70, and outer members disposed as front-and-rear (front and rear panels 10, 20), left-and-right (left and right panels 30, 40), and top-and-bottom (top and bottom panels 50, 60). At appropriate positions at the peripheries of the outer members are provided with holes 11, 21, 31, 41, 51 and 61 for fastening with isogonal solid combining members 80 by means of screws 90. (The combining members 80 are isogonal cubes, wherein a hole is drilled at three adjacent planes, respectively, for fastening screw pillars 82 of inner and outer screw teeth; the outer screw teeth are for fastening within the holes of the combining members, whereas the inner screw teeth are for fastening the screws to corresponding assembly panels. An enlarged partial view of a combining member is shown as in FIG. 1.) Through the screw pillars fastened at the three adjacent planes of the combining members, the planes are easily rotated for facilitating fastening thereof to the periphery of the computer casing.

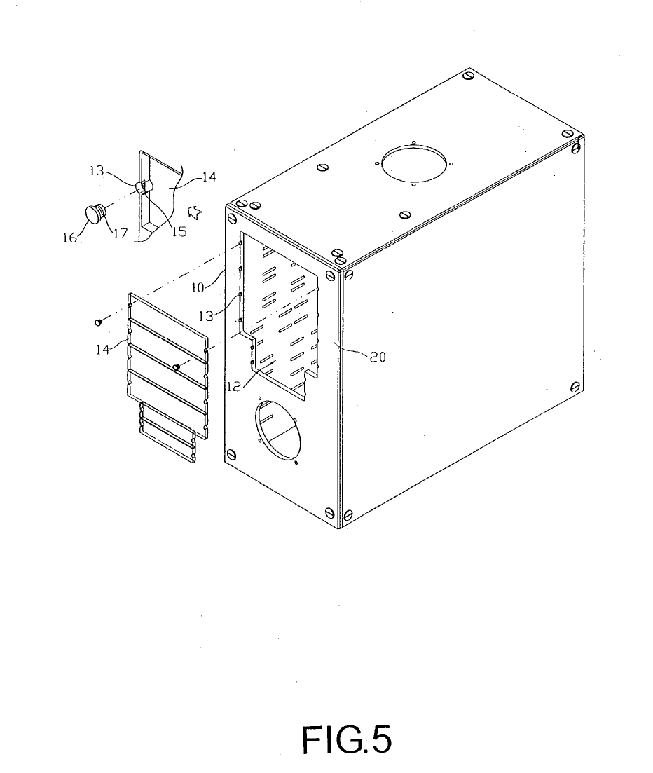

The panels for assembly are of standard specifications, wherein the front panel 10 is provided with three large and two small expansion slots 12, and at the bottom thereof are supplied with openings for a front fan, a side button and an LED indicating light. At the left and right sides of a demountable expansion panel 14, semi-circular holes 15 are provided at the two sides of the front panel corresponding to the expansion slots, and semi-circular holes 13 are provided at the expansion slots 13 (as indicated in an enlarged partial view in FIG. 5). The expansion panel is placed into the expansion slots and further accommodated by a button 16 of a rubber ring 17.

The rear panel 20 is provided with openings for a power supply, a rear fan, a host connection port and interface ports.

The top and bottom panels 50 and 60 are provided with holes 51 and 61 at the four corners thereof, and at the inner side thereof are provided with corresponding holes 52 and 62 for fastening with two partition panels 70. Equidistant or non-equidistant arc holes 71 are provided at the partition panels for placing devices such as hard disk, soft disk and CD-ROM in the expansion slots. The top and bottom parts of the partition panels are fastened correspondingly to the screw holes 72 at the top and bottom panels by means of screws. At the rim of the top panel is further provided with a ventilation hole for dissipating heat from the interior of the computer casing, and the bottom panel is further provided with an opening for an amplifier transmitting sounds.

The left and right panels 30 and 40 are similarly provided with holes 31 and 41 for fastening the combining members 80 by means of screws 90. The right panel is provided with a plurality of copper pillar holes 42 for fastening the copper pillars 43 to a motherboard. The left panel is further provided with two ventilation holes for increasing thermal convection for heat dissipation within the computer casing along with other additional ventilation holes provided at respective panels.

Conclusive from the above, the display-oriented computer casing provided by the invention adopts multi-color and transparent panels for assembly fastened by combining members at three adjacent planes by means of outer screws, thereby creating characteristics as being ready for assemble and disassemble as well as directly displaying the interior thereof. And while this invention has been particularly shown and described with references to preferred embodiments thereof, it will be understood by those skilled in the art that various changes and adaptions may be made therein without departing from the true spirit and scope of the invention as defined by the appended claims.

What is claimed is:

1. A display-oriented computer casing comprising a front panel, a rear panel, a left panel, a right panel, a top panel, a bottom panel, two partition panels, and a plurality of combining members and screws; wherein the panels for assembly and combining members are made of multi-color and transparent acrylic materials, and screw pillars at three adjacent planes of the combining members are used for assembling and fastening the panels by means of screws through corresponding holes at respective panels, thereby directly displaying the interior and configurations within the computer casing.
